(19) United States
(12) Patent Application Publication
(10) Pub. No.: US 2004/0218579 A1
(43) Pub. Date: Nov. 4, 2004

(54) Network device and data packet communication method for improving data packet transmission efficiency in a mobile ad hoc network

(75) Inventor: Cheol-hong An, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 10/774,494

(22) Filed: Feb. 10, 2004

(30) Foreign Application Priority Data
May 3, 2003 (KR) 10-2003-0028423

(51) Int. Cl. H04L 5/22

(52) U.S. Cl. 370/349

(57) ABSTRACT

A method of transferring a data packet to another network device, the method includes checking specific information included in a header of the transmitted data packet, and selectively performing either a first transmission mode in which the data packet is transferred without reconfiguration of the transmitted data packet, or a second transmission mode in which the transmitted data packet is transferred after reconfiguration thereof, according to the specific information.

### BACKGROUND OF THE INVENTION

This application claims the benefit to Korean Patent Application No. 10-2003-0028423 filed on May 3, 2003 in the Korean Intellectual Property Office, the disclosure of which is incorporated herein by reference.

1. Field of the Invention

The present invention relates to data packet communications in a mobile ad hoc network, and more particularly, to a network device and a data packet communication method for improving data packet transmission efficiency in a mobile ad hoc network.

2. Description of the Related Art

Significant technical advances in the wireless network field have resulted in a variety of wireless products available on the market. As the wireless network environment is provided accordingly, the application of IP(Internet Protocol) network techniques widely used in wired network environments to wireless network environments is advantageous in that applications in wired network environments can also be directly applied in wireless network environments.

FIG. 1 shows a conventional protocol stack structure for wireless network communications, which is used to transmit and receive data packets.

FIG. 2 shows header sizes and payloads created in respective protocol layers on IP networks. Where streaming data are sent from an application layer to a transport layer, an 8-byte UDP(User Datagram Protocol) header is attached to the streaming data. In a network layer, a 20-byte EP header is further attached thereto and the streaming data is sent to an LLC (Logical Link Control) sub-layer. The streaming data is then sent to a wireless medium through a MAC (Media Access Control) sub-layer and a physical layer while respective layer headers are attached thereto. At a receiving part(not shown), the data are transferred to upper layers while the respective headers, which have been attached at the respective layers, are removed. In such a process, since a mobile ad hoc network environment is generally constructed of the Intranet that does not require IP writing, information on all headers of the EP data packet is not necessarily required. Nevertheless, such unnecessary information occupies a frequency band, resulting in inefficient data packet transmission.

### SUMMARY OF THE INVENTION

Accordingly, one aspect of the present invention is to provide a method of improving data packet transmission efficiency under the same conditions in a mobile ad hoc network by performing reconfiguration of a header portion of an EP data packet upon transmission thereof.

Additional aspects and/or advantages of the present invention will be set forth in part in the description which follows and, in part, will be obvious from the description, or may be learned by practice of the invention.

To achieve the above and/or other aspects of the present invention, there is provided a network device for improving a data packet transmission efficiency in a mobile ad hoc network. When transferring a data packet to another network device, the network device is adapted to selectively perform either a first transmission mode in which the data packet is transferred without reconfiguration of the transmitted data packet, or a second transmission mode in which the transmitted data packet is transferred after reconfiguration thereof, based on specific information included in a header of the transmitted data packet.

When receiving the data packet from another network device, the device may be further adapted to selectively perform either a first receiving mode in which, when the received data packet is the data packet transferred in the first transmission mode, reconfiguration is not made to the received data packet, or a second receiving mode in which, when the received data packet is the data packet transferred in the second transmission mode, received data are restored to an original data packet state before being subjected to the reconfiguration made in the second transmission mode.

To achieve the above and/or other aspects of the present invention, there is provided a method of transmitting and receiving a data packet in a mobile ad hoc network. When transferring the data packet to another network device, the method comprises transmitting of the data packet including checking specific information included in a header of the data packet, and selectively performing either a first transmission mode in which the data packet is transferred without reconfiguration of the transmitted data packet, or a second transmission mode in which the transmitted data packet is transferred after reconfiguration thereof, based on the specific information.

In case of receiving a data packet from another network device, the method may further comprise receiving of the data packet including checking which of the first and second transmission modes is used to transfer the data packet to be received, and selectively performing a first receiving mode in which, when the received data packet is the data packet transferred in the first transmission mode, restoration is not made to the received data packet, or a second receiving mode in which, when the received data packet is the data packet transferred in the second transmission mode, received data are restored to an original data packet state before being subjected to the reconfiguration made in the second transmission mode.

The transmitted data packet may comprise an IP packet, and the specific information may include a field of Type of Service included in the header of the IP packet.

### BRIEF DESCRIPTION OF THE DRAWINGS

The above and/or other aspects, features and advantages of the present invention will become apparent from the following description of the aspects of the present invention taken in conjunction with the accompanying drawings, of which:

FIG. 1 is a block diagram illustrating a conventional protocol stack structure for wireless network communications, which is used to transmit and receive data packets;

FIG. 2 is a block diagram illustrating header sizes and payloads created in respective protocol layers;

FIG. 3 is a block diagram illustrating a protocol stack structure and a method of transmitting and receiving a data packet between network devices according to embodiments of the present invention;

FIG. 4A is a flowchart illustrating a method of transferring a data packet in an adaptation layer according to an embodiment of the present invention; and

FIG. 4B is a flowchart illustrating a method of receiving a data packet in an adaptation layer according to an embodiment of the present invention.

### DETAILED DESCRIPTION OF THE INVENTION

Reference will now be made in detail to the aspects of the present invention, examples of which are illustrated in accompanying drawings, wherein like reference numerals refer to like elements throughout. The aspects are described below in order to explain the present invention by referring to the figures.

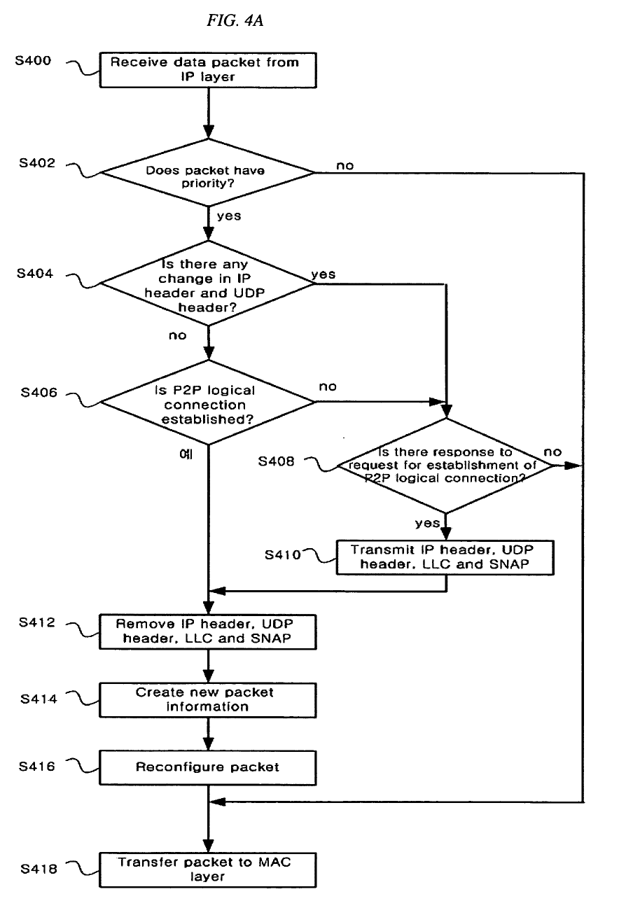

FIG. 3 shows a protocol stack structure according to an embodiment of the present invention. In a conventional mobile ad hoc network, a protocol stack may include a wireless physical layer 330 or 380, a wireless MAC layer 325 or 375, an IP layer 315 or 365, a transport layer 310 or 360 comprising UDP and TCP(Transport Control Protocol), and an application layer 305 or 355 to transmit and receive data. In the present invention, when receiving a packet from an upper layer between the IP layer 315 or 365 and the wireless MAC layer 325 or 375, the size of a header of the packet is reduced and other data are added to the reduced amount to yield a modified packet which in turn is transmitted to a lower layer. When receiving a packet from the lower layer, the received packet is restored to an original packet format as needed in the IP layer. Therefore, the size of transmitted data per packet can be increased without having any influence on each layer, resulting in higher transmission efficiency. For example, in case of audio/video (A/V) streaming data other than general data, the A/V data are generally transmitted through the User Datagram Protocol (UDP). In this case, since there is little change in a UDP header, the aforementioned advantages can be obtained where the present invention is applied thereto.

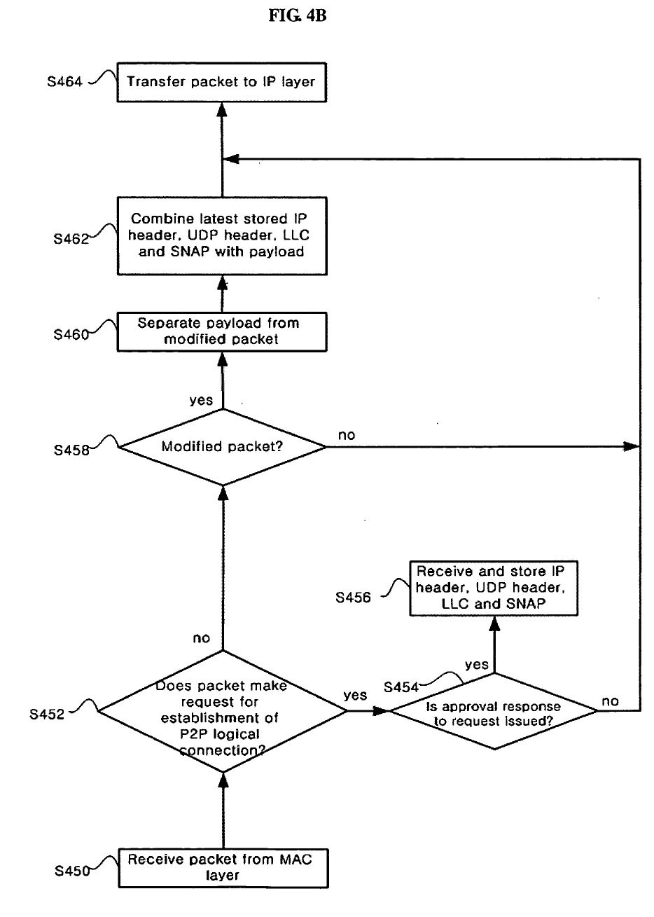

As shown in FIG. 3, in a data-transmitting device 300, where an adaptation layer 320 according to the present invention receives streaming data, the adaptation layer 320 converts the received streaming data into a modified packet format, which in turn are transmitted to a lower layer, i.e. the wireless MAC layer 325. When the adaptation layer 320 receives non-streaming data, the adaptation layer 320 directly transmits them in an existing standard format to the MAC layer 325 without converting the non-streaming data. Specific operations of the adaptation layer 320 will be described later with reference to FIG. 4A. The wireless MAC layer 325 of the data-transmitting device 300 receives the modified packet or standard packet and transfers the received packet to the wireless physical layer 330 and the wireless MAC layer 375 of a data-receiving device 350 via, for example, a wireless medium 390.

When the adaptation layer 370 of the data-receiving device 350 according to the present invention receives a standard packet of non-streaming data from the wireless MAC layer 375, the adaptation layer 370 transfers the packet to an upper layer, i.e. IP layer 365, as is. When the adaptation layer 370 of the data-receiving device 350 receives the modified packet, the packet is restored to an original packet and transferred to the upper layer, i.e. EP layer 365.

FIG. 4A illustrates a case where an adaptation layer according to the present invention receives a packet from an upper layer and transfers it to a lower layer, and FIG. 4B illustrates a case where an adaptation layer according to the present invention receives a packet from a lower layer and transfers it to an upper layer.

FIG. 4A shows a flowchart illustrating a method of transferring a data packet in the adaptation layer according to an embodiment of the present invention. In operation 400, the adaptation layer receives the packet from the IP layer corresponding to the upper layer. When 3-bit precedence information of a 1-byte field of Type of Service included in a header of the received IP packet has priority, information of the remaining five bits is referred to, so as to determine whether the packet received from the upper layer is transferred to the MAC layer corresponding to the lower layer by using the present invention or without using the present invention as is in operation 402. Where the priority is lower than a predefined reference priority, the packet is directly transferred to the MAC layer in operation S418. Where the priority is not lower than the predefined reference priority, the packet is checked to determine whether there are changes in the IP header and UDP header of the packet received from the IP layer in operation S404. For example, when a destination address is changed while audio and video data are streamed, the IP header is changed.

Where there are no changes in the IP header or UDP header, and where a point to point (P2P) logical connection to a receiving part (not shown) is not established in operation S406, a request for establishment of the P2P logical connection is made to the receiving part and the adaptation layer waits for a response thereto in operation S408. When there is no response, the packet received from the IP layer is directly transferred to the MAC layer corresponding to the lower layer in operation S418. When an approval response that allows the requested connection is received, the IP header, UDP header, LLC and SNAP of the packet received from the IP layer are transferred to the receiving part through the established P2P logical connection in operation S410. When the P2P logical connection to the receiving part is established, the IP header, UDP header, LLC and SNAP are removed from the packet received from the EP layer in operation S412 and new packet information is created in operation S414.

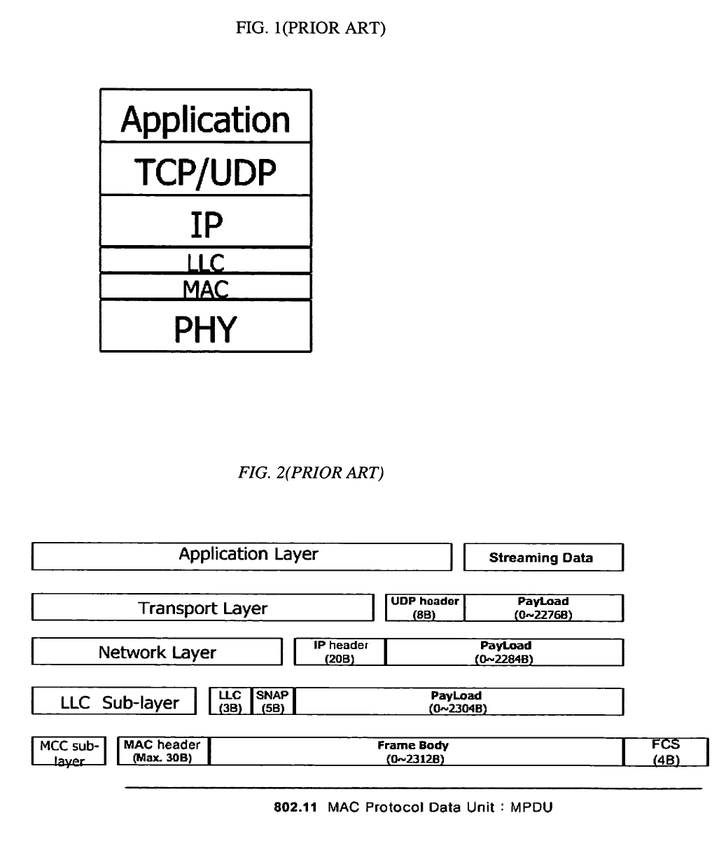

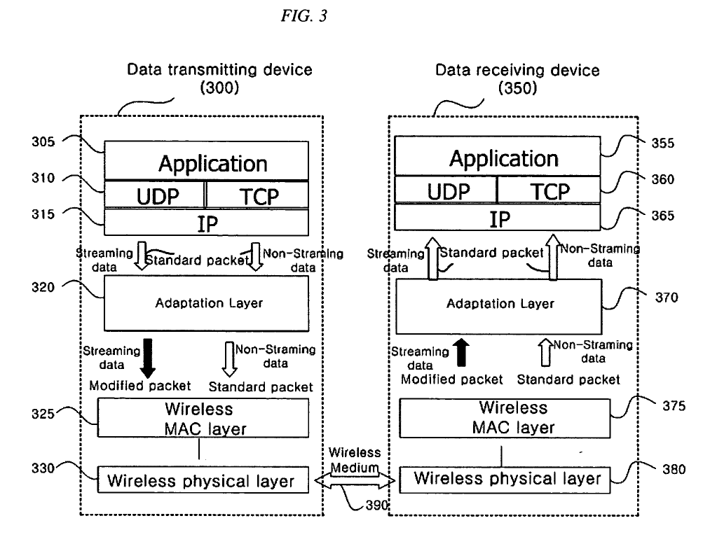

At this time, the new packet information may include one byte of a destination service access point (DSAP), 4 bits of the number of EP headers, four bits of the number of UDP checksums, two bytes of the total length of EP and two bytes of UDP checksums, which constitute the total 6-bytes of new packet information. That, as shown in FIG. 1, although the lengths of the IP header, UDP header, LLC and SNAP sum to 36 bytes in the related art, the present invention shows that 30 bytes can be saved by extracting only necessary information that occupies 6 bytes. This enables other data to be further carried due to the saved 30 bytes. Therefore, data packet transmission efficiency can also be improved.

Referring back to FIG. 4A, the newly created packet information is combined with a substantial data portion except for the header portion in each protocol layer of the packet received from the IP layer, resulting in a reconfigured packet in operation S416. The reconfigured packet is transmitted to the MAC layer in operation S418 to be transferred to the receiving part.

FIG. 4B shows a flowchart illustrating a method of receiving a data packet in the adaptation layer according to an embodiment of the present invention. When a packet is received from the MAC layer in operation 450, it is determined whether the received packet is a packet that requests the establishment of a P2P logical connection in operation 452. Where the packet requests the establishment of a P2P logical connection, it is determined whether a response thereto is issued in operation 454. When it is determined that a response is not issued, the received packet is directly transferred to the IP layer in operation 464. When a response to the establishment of a P2P connection is issued, the IP header, UDP header, LLC and SNAP are received and stored through the established P2P connection in operation 456. Where the packet received from the MAC layer is not a packet that requests the establishment of a P2P logical connection, it is determined whether the received packet is a standard packet or a packet modified at the sending part according to the present invention in operation 458. Where it is determined that the received packet is the standard packet, the received packet is directly transferred to the IP layer in operation 464. Where the received packet is the modified packet, a payload included in the modified packet is separated there from in operation 460. In other words, with the use of the 2-byte information on the total length of IP in the header of the modified packet, the payload is divided into a payload corresponding to the total length of IP and the remaining payload. The latest stored IP header, UDP header, LLC and SNAP are combined with the payload corresponding to the total length of IP in operation 462 and transferred to the IP layer in operation 464. Thereafter, the remaining payload is combined with a payload separated from a modified packet being subsequently received and thereafter combined with the latest stored IP header, UDP header, LLC and SNAP to be transferred to the IP layer.

According to the present invention, unnecessary header information is reconfigured to improve the data packet transmission efficiency in a mobile ad hoc IP network environment. For example, since audio/video streaming data other than general data are generally transferred through UDP, there is little change in a UDP header. Accordingly, the data packet transmission efficiency can be improved by applying the present invention.

Although a few aspects of the present invention have been shown and described, it would be appreciated by those skilled in the art that changes might be made in this embodiment without departing from the principles and spirit of the invention, the scope of which is defined in the claims and their equivalents.

What is claimed is:

1. A mobile ad hoc network device, comprising an adaptation unit which selectively performs one of a first transmission mode in which a data packet is transferred without reconfiguration of the transmitted data packet, and a second transmission mode in which the transmitted data packet is transferred after reconfiguration thereof, according to specific information included in a header of the transmitted data packet.

2. The device as claimed in claim 1, wherein the adaptation unit selectively performs one of a first receiving mode in which a received data packet is not restored when the received data packet is transferred in the first transmission mode and a second receiving mode in which the received data packet is restored to a data packet state before being subjected to the reconfiguration, when the received data packet is transferred in the second transmission mode.

3. The device as claimed in claim 1, wherein, in the second transmission mode, the adaptation unit removes header information of the transmitted data packet to create new packet information and adds additional data thereto.

4. The device as claimed in claim 3, wherein the new packet information comprises a destination service access point (DSAP), a total length of IP(Internet Protocol), a number of IP headers, UDP(User Datagram Protocol) checksums, and a number of UDP checksums.

5. The device as claimed in claim 4, wherein the new packet information comprises four bits of the number of UDP checksums, two bytes of the total length of IP, and two bytes of the UDP checksums.

6. The device as claimed in claim 1, wherein the transmitted data packet comprises an IP packet.

7. The device as claimed in claim 1, wherein the specific information comprises a field of Type of Service included in the header of the transmitted data packet.

8. A method of at least one of transmitting and receiving a data packet in a mobile ad hoc network, the method comprising transmitting of the data packet including selectively performing one of a first transmission mode in which the data packet is transferred without reconfiguration thereof, and a second transmission mode in which the data packet is transferred after reconfiguration thereof, according to specific information included in a header of the data packet.

9. The method as claimed in claim 8, further comprising receiving of the data packet including selectively performing one of a first receiving mode in which the data packet is not restored when the data packet is transferred through the first transmission mode, and a second receiving mode in which the data packet is restored to a data packet state before being subjected to reconfiguration when the data packet is transferred through the second transmission mode.

10. The method as claimed in claim 8, wherein the reconfiguration of the data packet comprises removing header information of the data packet to create new packet information and adding additional data thereto.

11. The method as claimed in claim 10, wherein the new packet information comprises a destination service access point (DSAP), a total length of IP, a number of IP headers, UDP checksums, and a number of UDP checksums.

12. The method as claimed in claim 11, wherein the new packet information comprises four bits of the number of UDP checksums, two bytes of the total length of EP, and two bytes of the UDP checksums.

13. The method as claimed in claim 8, wherein the data packet comprises an IP packet.

14. The method as claimed in claim 8, wherein the specific information comprises a field of Type of Service included in the header of the data packet.

15. The device as claimed in claim 2, wherein in the second transmission mode, the adaptation unit removes header information of the transmitted data packet to create new packet information and adds additional data thereto.

16. The device as claimed in claim 15, wherein in the second receiving mode, the adaptation unit restores data included in the received data packet to respective data packets before being subjected to reconfiguration.

17. The device as claimed in claim 16, wherein in the second receiving mode, the adaptation unit combines the data of the respective data packets with corresponding header information.

18. The device as claimed in claim 4, wherein the new packet information comprises six bytes.

19. A mobile ad hoc network device, comprising an adaptation unit which selectively performs one of a first receiving mode in which a data packet is received without restoration and a second receiving mode in which the received data packet is restored to a data packet state before being subjected to reconfiguration, according to whether the data packet is reconfigured based on specific information included in a header of the data packet.

20. The device as claimed in claim 19, wherein the reconfiguration of the data packet comprises removing header information of the data packet to create new packet information and adding additional data thereto.

21. A network device comprising at least one of a data transferring unit and a data receiving unit which selectively reconfigures a data packet to be transferred according to specific information included in a header of the data packet, wherein said at least one of the data transferring unit and the receiving unit reconfigures the data packet by removing header information of the data packet to create new packet information and adding additional data thereto.

22. The device as claimed in claim 21, wherein in response to the data packet received thereto being the reconfigured data packet, said at least one of the transferring unit and the receiving unit restores the reconfigured data packet to an original data packet format.

23. The device as claimed in claim 21, wherein the new packet information includes a destination service access point (DSAP), a total length of IP, a number of IP headers, user datagram protocol (UDP) checksums, and a number of UDP checksums.

24. The device as claimed in claim 21, wherein the data packet comprises audio/video (A/V) streaming data.

25. The device as claimed in claim 21, wherein said at least one of the data transferring unit and the receiving unit comprises an adaptation layer which selectively reconfigures the data packet to increase a transmission efficiency and restores the reconfigured data packet to an original data packet format.

26. A method of at least one of transmitting and receiving a data packet in a mobile ad hoc network, the method comprising:
selectively reconfiguring the data packet according to specific information included in a header of the data packet, before transmitting the data packet; and
restoring the data packet to a data packet state before being subjected to the reconfiguration, if the received data packet has been reconfigured.

27. The method as claimed in claim 26, wherein the reconfiguration of the data packet comprises removing header information of the data packet to create new packet information and adding additional data thereto.

28. The method as claimed in claim 27, wherein the restoring of the data packet comprises restoring data included in the received data packet to respective data packets before being subjected to reconfiguration.

29. The method as claimed in claim 28, wherein the restoring of the data packet further comprises combining data of the respective data packets with corresponding header information.
